(19) United States
(12) Patent Application Publication
(10) Pub. No.: US 2002/0077960 A1
(43) Pub. Date: Jun. 20, 2002

(54) World Wide Web upsell system and method

(76) Inventors: Neil J. Kiely, Fulmouth, ME (US); Tracy L. Alves, Gorham, ME (US); Joshua M. Hurley, Cape Elizabeth, ME (US)

Correspondence Address: Farrell & Associates, P.C., P.O. Box 999, York Harbor, ME, 03911, US

(21) Appl. No.: 09/910,683

(22) Filed: Jul. 20, 2001

Related U.S. Application Data
(63) Continuation-in-part of application No. 09/621,396, filed on Jul. 21, 2000.

(51) Int. Cl. G06F 17/60

(52) U.S. Cl. 705/37

(57) ABSTRACT

An upsell system and method for use on the worldwide web. A system and method are provided in which upsell offers are presented to customers, who have placed orders with a website, by a third party upsell server. At or near the completion of the transaction, transaction details are communicated to the third party upsell server. The upsell server provides an offer directly to the customer. Should the customer accept the offer, an upsell order is processed by the upsell server in a manner that is seamless to the customer.

### BACKGROUND OF THE INVENTION

1. Technical Field

The present invention relates to network based commercial transactions, and more specifically, to a system and method for implementing post-sale upsell offers on the World Wide Web.

2. Related Art

With the explosion of retail and commercial transactions occurring on the World Wide Web (“web”), there exists an ongoing challenge to provide systems that can put sales offers in front of potential consumers. Typical methodologies currently used on the web include extensive marketing campaigns outside of the web, such as on television, billboards, etc., e-mail notification; and on-line marketing, such as banner ads. Unfortunately, each of the above-mentioned methodologies provides only an indirect system for driving potential consumers to a website. Assuming the potential customer even decides to visit the website, the consumer still needs to identify a particular product of interest, submit ordering details, and provide payment information, in order to complete a sale. Accordingly, the above-mentioned techniques provide only an indirect means for marketing goods and services.

Certain websites have attempted to facilitate the purchasing process by providing systems in which customers need not enter payment information after each subsequent visit to the website. For example, Amazon.com utilizes a one-click technology that allows customers the ability to buy merchandise from their site by merely clicking oil an item that is for sale at Amazon.com's website. The system relies upon payment information, previously collected at Amazon.com, to complete the sale, Unfortunately, such a system does not facilitate the buying process for goods and services outside of the Amazon.com website.

Accordingly, given the intensely competitive nature of the retail businesses on the web, improved systems are required to provide effective selling opportunities.

### SUMMARY OF THE INVENTION

The present invention addresses the above-mentioned problems by providing a system and method for implementing upsell commercial transactions on a network-based system such as the World Wide Web. In a first aspect, the invention discloses a method of transacting commerce on a network having a client system, an upsell server system, and an affiliate server system, comprising the steps of: downloading an affiliate order window to the client system from the affiliate server system; uploading transaction details from the client system to the affiliate server system; displaying a post-sale opportunity on the client system, wherein the post-sale opportunity includes upsell details that comprise the transaction details; if the post-sale opportunity is accepted at the client system, performing the steps of: transferring the upsell details to the upsell server system; and downloading an upsell offer from the upsell server to the client system; and if the upsell offer is accepted, processing an upsell order at the upsell server system using the upsell details.

In a second aspect, the invention discloses a system for transacting commerce on the world wide web, comprising: an affiliate website having a system for processing a transaction with a client and for receiving transaction details from the client; and an upsell server, wherein the upsell server includes: a system for capturing the transaction details from the client during the transaction between the affiliate website and the client; a system for providing an upsell offer to the client during the transaction between the affiliate website and the client; and a system for completing an upsell order with the client using the captured transaction details.

In a third aspect, the invention discloses a program product stored on a recordable media, that when executed, includes: means for capturing transaction details during the processing of a transaction between an affiliate server and a client; means for providing an upsell offer to the client during the transaction between the affiliate server and the client; and means for completing an upsell order with the client using the captured transaction details.

In a fourth aspect, the invention discloses a hub system for brokering upsell opportunities between affiliate servers and upsell servers, comprising: means for capturing upsell opportunities during the execution of transactions between each of the affiliate servers and their respective clients, wherein each upsell opportunity includes transaction details; and means for transmitting the captured upsell opportunities to at least one selected upsell server during the execution of said transaction.

In a fifth aspect, the invention discloses a system for transacting commerce on the world wide web, comprising: an affiliate website having a system for processing a transaction with a client, wherein the system includes receiving transaction details from the client; and an upsell server, wherein the upsell server includes: a system for capturing the transaction details during the transaction between the affiliate website and the client; and a system for providing upsell content to the client during the transaction between the affiliate website and the client.

In a sixth aspect, the invention provides a method of transacting commerce on a network having a client system, an upsell server system, and an affiliate server system, comprising the steps of: downloading an affiliate order window to the client system from the affiliate server system; uploading transaction details from the client system to the affiliate server system; transferring the transaction details to the upsell server system; displaying a post-sale opportunity on the client system; if the post-sale opportunity is accepted at the client system, performing the steps of: downloading an upsell offer from the upsell server to the client system; and if the upsell offer is accepted, processing an upsell order at the upsell server system using the upsell details.

It is therefore an advantage of the present invention to provide a system and method for offering upsell content, goods and services from a remote website.

It is therefore a further advantage of the present invention to provide a system in which an upsell order can be completed on a remote website without having to obtain customer and payment information.

It is therefore a further advantage of the present invention to provide a system in which any website can implement an upsell program without having to substantially rewrite their interface or affiliate with a third party.

### BRIEF DESCRIPTION OF THE DRAWINGS

The preferred exemplary embodiment of the present invention will hereinafter be described in conjunction with the appended drawings, where like designations denote like elements, and:

FIG. 1 depicts an operational diagram of the upsell system and method in accordance with a preferred embodiment of the invention.

FIG. 1A depicts an alternative embodiment of the system and method depicted in FIG. 1.

FIG. 2 depicts an operational diagram of an alternative embodiment of an upsell method and system.

FIG. 3 depicts an operational diagram of a second alternative embodiment of an upsell system and method.

FIG. 4 depicts an affiliate order window in accordance with a preferred embodiment of the present invention.

FIG. 5 depicts a bonus box window in accordance with a preferred embodiment of the present invention.

FIG. 6 depicts an upsell window containing an upsell offer in accordance with a preferred embodiment of the present invention.

### DETAILED DESCRIPTION OF THE DRAWINGS

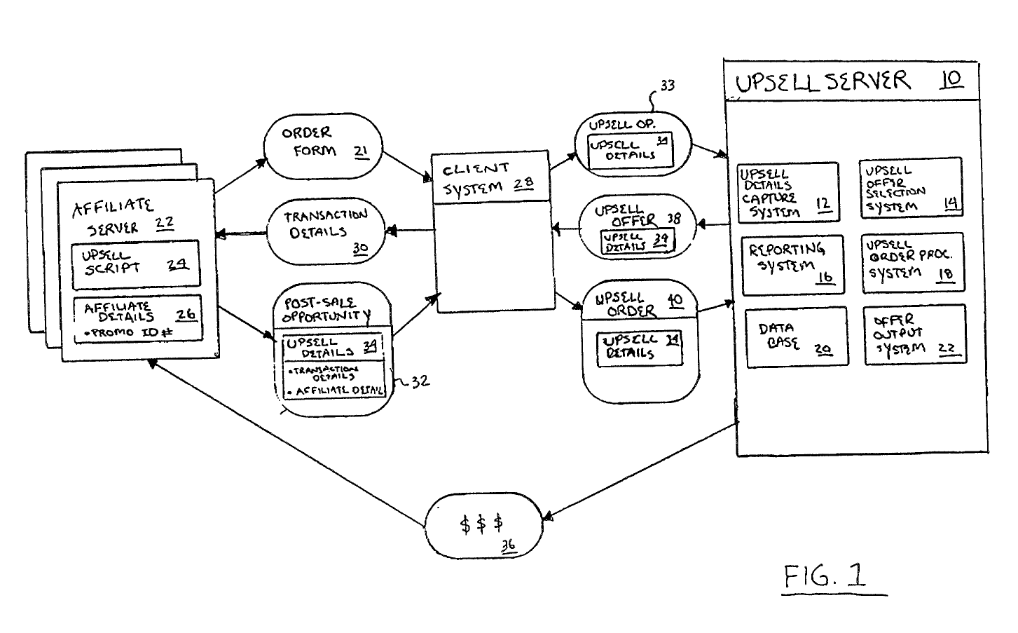

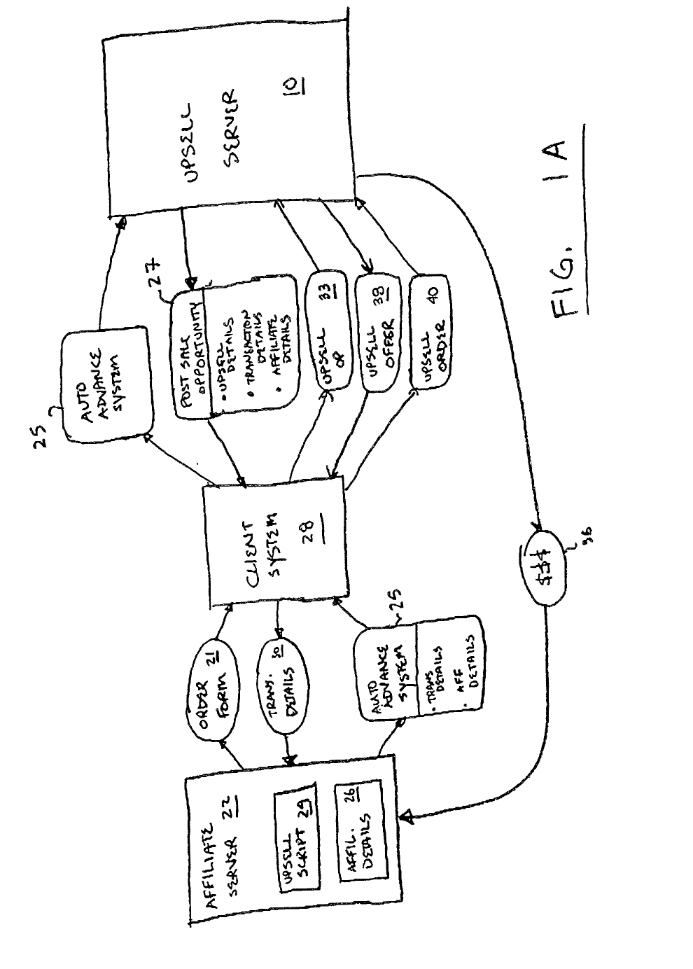

Referring now to the figures, FIG. 1 depicts an operational diagram of the invention. In particular, the system shown includes an affiliate server 22, a client system 28, and an upsell server 10. It is understood that any number of affiliate servers, upsell servers, and/or client systems may participate in the described system Affiliate server 22 may comprise any type of network or internet server system (e.g., a website) that offers goods, services, or content to customers via a client system 28. Client system 28 may comprise any type of system that is capable of performing a transaction with the affiliate server 22, e.g., a web browser, a network workstation, a dumb terminal, a web-based cell phone, a personal digital assistant (PDA), internet appliance, etc. In a typical scenario, affiliate server 22 comprises a web-based retail site (i.e., a vendor) that takes orders for goods over the internet from a customer at client system 28. Client system 28 provides the interface through which a customer can establish a communication link, and transact or submit an order to affiliate server 22.

During the course of a transaction involving client system 28 and affiliate server 22, an order form 21, or other data collection mechanism is provided to client system 28. Subsequently, transaction details 30 are communicated back from client system 28 to affiliate server 22. Transaction details 30 may comprise any type of information, and generally include customer information, e.g., name, address, payment details, etc., and order information (e.g., product id, quantity, etc.). Payment details may, for example, include customer credit card information. Such transactions are utilized regularly on the web. Additional details, e.g., preferences, may likewise be communicated to the affiliate server. For the purposes of this disclosure, the transaction may be considered complete, i.e., the sale is consummated, once: (1) the transaction details 30 and any additional details have been provided to affiliate server 22; (2) the order is accepted by the affiliate server 22; (3) the customer confirms the order; and (4) control of client system is returned to the customer.

It should be recognized that while transaction details 30 are typically entered by a user at client system 28 at the time of purchase, some of the information may be gathered from a previous transaction. For example, customer information may already reside in a database at affiliate server 22 from a previous order. In this case, specific customer information may, for example, be identified in the database after the user enters a password or information from a cookie on client system 28 is presented to the affiliate server. Thus, the only transaction details being communicated from the client system 28 to the affiliate server 22 are the order details. Similarly, it is possible that the user previously filled out an order form, but waited to a later time to execute the purchase. In this case, the only transaction details 30 communicated from the client at the time of purchase would be an authorization to execute the order.

After an order is submitted, but before control of client system 28 is returned to the customer, the present invention implements a mechanism to provide an additional or post-sale offer to the customer. This type of offer is generally referred to as an “upsell.” Upsell offers are particularly effective in this instance because: (1) the consumer is in a buying mode; (2) the consumer has already gone through the process of providing their customer information; and (3) profile details, e.g., specific product interests, etc., about the customer arc immediately available, thus allowing the vendor to better target products at the customer.

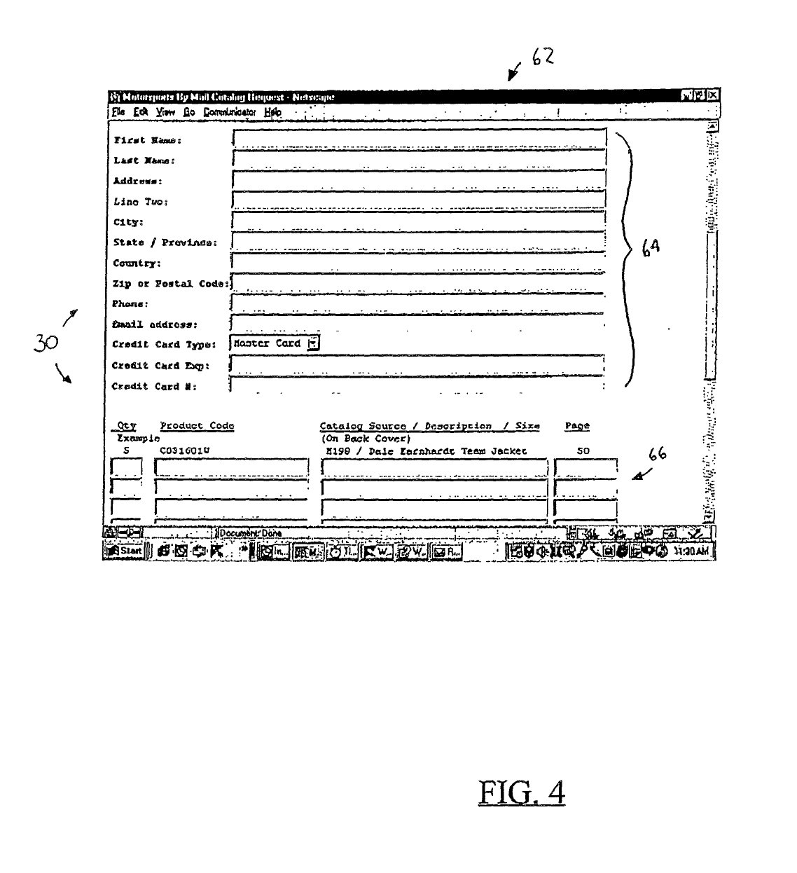

To implement the upsell process, the customer is first notified of a post-sale opportunity 32 during the transaction, i.e., before control is passed back to client system 28. Post-sale opportunity 32 may comprise any type of notification to the customer via client system 28 that the customer is being given an opportunity to make an additional transaction. For example, post-sale opportunity 32 may comprise a pop-up window that notifies the customer of a potential special offer, as described later with regard to FIG. 4. Post-sale opportunity 32 can be implemented from an upsell script 24 that is stored on affiliate server 22. Upsell script 24 can be run at any time while client system 28 is still in communication with affiliate server 22, and can be initiated in any number of ways. In the preferred embodiment, the script 24 is inserted into order form 21, and run when customer submits an order back to the affiliate server 22. To implement the process, the script can be initiated or inserted in a “Post Form Process Page”; in an HTML submit button; or as a call to a JavaScript function in the order form's OnSubmit event or the browser's OnUnload event.

When the order is submitted, two things occur. First a secondary browser or pop-up window (i.e., post-sale opportunity 32) is created with a post-sale opportunity message and appears on the client system with upsell details 34 embedded in the HTML code. Second, the order form 21 is transmitted back to the affiliate server 22, where the original order is processed, and a thank you/receipt/acknowledgment page may be displayed. Appended to post-sale opportunity 32 arc upsell details 34, which include both transaction details 30, and affiliate details 26. Generally, the affiliate details 26 comprise information about the affiliate (e.g., a promotional ID, which may include an affiliate ID and product ID), while the transaction details 30 comprise information about the customer.

In the preferred embodiment, a third party system, namely upsell server 10, is utilized to handle the upsell process. If the customer accepts post-sale opportunity 32 (e.g., clicks a button, graphic, or link in a pop-up window), then an upsell opportunity 33 is transferred to upsell server 10 from client system 28. Upsell opportunity 33 may include some or all of the information in upsell details 34. In exchange for the upsell opportunity 33, upsell server 10 may compensate 36 affiliate server 22. Upsell opportunity 33 is provided to upsell server 10 so that upsell server 10 can make an upsell offer 38 directly to client system 28.

Once upsell server 10 obtains upsell opportunity 33 from client system 28, upsell server 10 can download an upsell offer 38 to client system 28. If client system 28 accepts the upsell offer 38, then an upsell order 40 is placed with upsell server 10. In the preferred embodiment, upsell details 34 are transmitted back and forth between the client system 28 and upsell server 10, so that upsell server 10 does not have to query the customer for further information to close a sale. Because upsell server 10 does not need to again ask the customer for customer details (e.g., name, address, and payment information), a seamless and effortless transaction for the customer results.

An alternative embodiment for implementing the invention is depicted in FIG. 1A. In particular, rather than generating the post-sale opportunity message from the affiliate server, the post-sale opportunity message is generated from the upsell server 10. In this case, an auto advance system 25 is utilized to automatically forward the transaction and affiliate details to the upsell server 10 via client 28, without the user taking any action. Specifically, when an order is submitted by client system 28, a secondary browser or pop-up window appears on the client system, delivered from the affiliate server 22. After a momentary delay, an HTML (hypertext mark-up language) form that contains embedded HTML code with the necessary details is automatically forwarded to upsell server 10 via client 28.

Subsequently, upsell server 10 will deliver the post-sale opportunity message 27 to the client system 28 in the secondary browser or pop-up window. The user can then accept or reject the post sale opportunity 27. While from the user's perspective, both embodiments appear similar, the embodiment depicted in FIG. 1A provides more flexibility for the upsell server 10. Namely, upsell server 10 can better control what message will appear in the post-sale opportunity 27.

In both embodiments, information is preferably transferred using standard hypertext mark-up language (HTML). Thus, upsell details 34 may be transferred between the affiliate server 22, client system 28 and upsell server 10 as HTML hidden values, as needed. Similarly, any functional code can be transferred as invisible HTML code. Thus, JavaScript code may be embedded or linked to the order form 21 or the affiliate's thank you/receipt/acknowledgment page, which will trigger the post-sale opportunity (i.e., call the pop-up window to open) and dynamically write the upsell details 34 as HTML code into the post-sale opportunity (i.e., the pop-up window). The JavaScript code can accomplish this by simply assigning the information typed into the order form 21 (transaction details) into HTML hidden input values. A “Post Process Form Page” in which the affiliate provides the transaction details via an affiliate server side routine can also provide this. These values are then written to the pop-up window when the window is opened.

In the embodiment depicted in FIG. 1, the HTML hidden input values are transferred to upsell server 10 with the click of a button or link in the pop-up window. Conversely, in the embodiment depicted in FIG. 1A, the HTML hidden input values are automatically transferred to upsell server 10 by auto advance system 25. In either case, when a window containing the upsell offer 38 is sent back from to the client, it will likewise contain these hidden values. Thus, preferably, the transaction details 30 will only be stored in the upsell server database 20 after the user accepts the offer by placing the upsell order 40.

Upsell server 10 may comprise various mechanisms for handling the upsell process. For instance, upsell server 10 may include an upsell details capture system 12, an upsell offer selection system 14, a reporting system 16, an upsell order processing system 18, a database 20, and an offer output system 22.

Upsell details capture system 12 captures necessary upsell details 34 as they are transferred from client system 28. Once captured, the details can be stored in database 20. Reporting system 16 provides a system in which captured customer data can be shared or sold back to affiliate server 22 to further enhance the affiliate server's knowledge of their customer base and customer buying habits.

Upsell offer selection system 14 provides the mechanism by which an upsell offer is selected for the particular customer at client system 28. Factors utilized in selecting an upsell offer might include the transaction details 30, the promotion ID number from the affiliate, or a third party data source. Thus, if the customer ordered a new golf club, which could be captured in transaction details 30, the upsell offer could be tailored to the golf industry. Alternatively, if the order involved a music CD, the upsell offer could relate to the music industry. If simply the promotional ID number was used, the upsell offer would likely be selected so as to entice a typical customer of affiliate server 22.

Upsell order processing system 18 provides the mechanism by which the upsell order 40 can be tracked, processed and/or fulfilled. It should be noted that upsell order 40 is generally processed and fulfilled separately from the original order submitted by the customer to affiliate server 22. Thus, in this embodiment, upsell order 40 is offered and processed by a third party remote from any transaction occurring between the affiliate server 22 and the client system 28.

Offer output system 22 outputs upsell offer 38 to client system 28 independently of the transaction occurring between client system 28 and affiliate server 22. However, in order to make the transaction appear seamless, offer output system 22 can display the upsell offer 38 in a format that matches the affiliate's web site. Thus, it will appear from the client system 28 that the customer is still in communication with affiliate server 22. Thus, as far as the customer is concerned, there is only a single interface in which an original order, and an upsell order, have been submitted.

It should be recognized that the upsell offer 38 provided to the client system 10 need not be limited to product offers where formal acceptance is immediately sought. Rather, any type of post-sale content could be transmitted back to the client system 28 from upsell server 10. Post-sale content could include, for example, advertisements, banner ads, product information, hypertext links, etc. In this situation, upsell orders would not necessarily be placed back to upsell server 10.

It is recognized that affiliate server 22 may lack the capability, or have security concerns regarding forwarding transaction details 30 to upsell server. In these cases, the affiliate server 22 could simply just transfer a unique identifier to upsell server 10, which would be used by upsell server 10 to pre-process orders. A list of the identifiers could then be sent back to the affiliate server 22 (e.g., in a daily batch mode). The affiliate server 22 could then send the associated transaction details 30 to the upsell server 10 to complete the upsell orders. If the affiliate server is incapable of generating unique identifiers, a JavaScript routine could be used to find a unique identifier on the order screen in the original order (e.g., an order number) between the user and the affiliate server 22. In addition, rather than transferring the identifiers in a batch mode from the upsell server 10 to the affiliate server 22 as suggested above, each identifier could be transferred in real-time back to the affiliate server using, for example, an XML/Soap system

FIGS. 4-6 depict screen-shots that display an example of the process as seen from client 28 Referring first to FIG. 4, a client interface 62 is shown for collecting transaction details 30 from a customer during a typical web-based transaction. The transaction details 30 include customer information 64, i.e., name, address, phone number, credit card number, etc., and order details 66, i.e., quantity, product number, description, etc. Client interface 62 is a typical order form web interface that is utilized as part of an order process. Any variation of this type of interface could likewise be utilized and is within the scope of this invention Once the customer has filled in customer information 64 and order details 66, a submit button or the like can be used to transmit the data to the affiliate server 22 for processing. Once the order is submitted, the on-line transaction between the client and affiliate is almost complete, and the order will be processed by the website vendor.

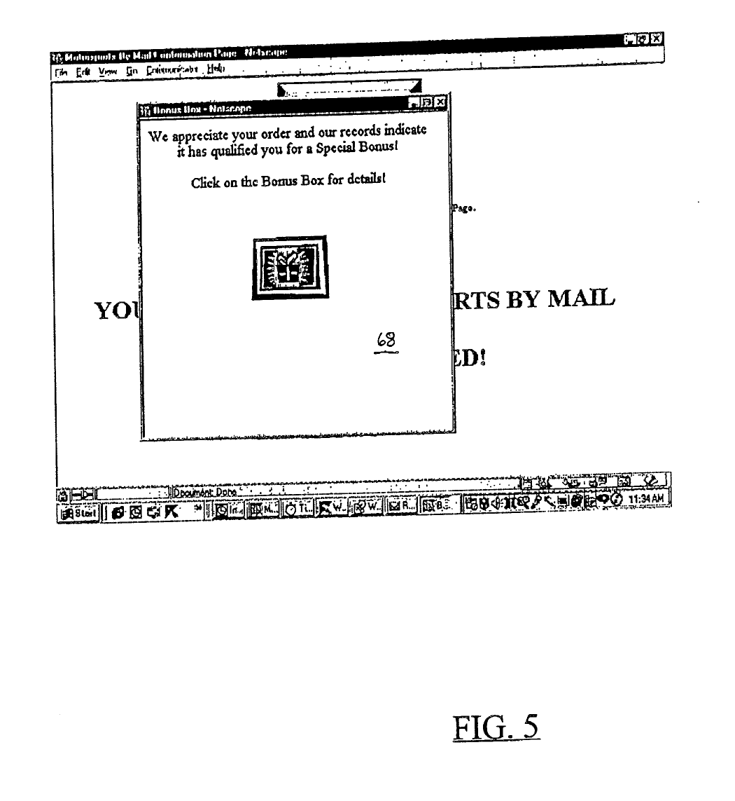

Referring now to FIG. 5, after the customer submits the order, and prior to returning control of client 28 back to the customer, a post-sale opportunity is presented to the customer in the form of a pop-up window 68 having a post-sale opportunity message. The pop-up window 68 may be downloaded to client system 28 from affiliate server 22. Should the customer be interested in accepting the post-sale opportunity, the customer can click on the bonus box in the pop-up window 68. Otherwise, the customer can click on the “X” in the upper right-hand corner to indicate that they are not interested in the post-sale opportunity. If the customer accepts the post-sale opportunity, then control of the upsell process is passed to upsell server 10. Specifically, upsell details 34 are transmitted to upsell server 10, notifying upsell server 10 of an upsell opportunity with client system 28.

In addition, as described with reference to the embodiment shown in FIG. 1A, the message contained in pop-up window 68 can be generated by the upsell server after the auto advance system 25 forwarded the necessary details to upsell server 10.

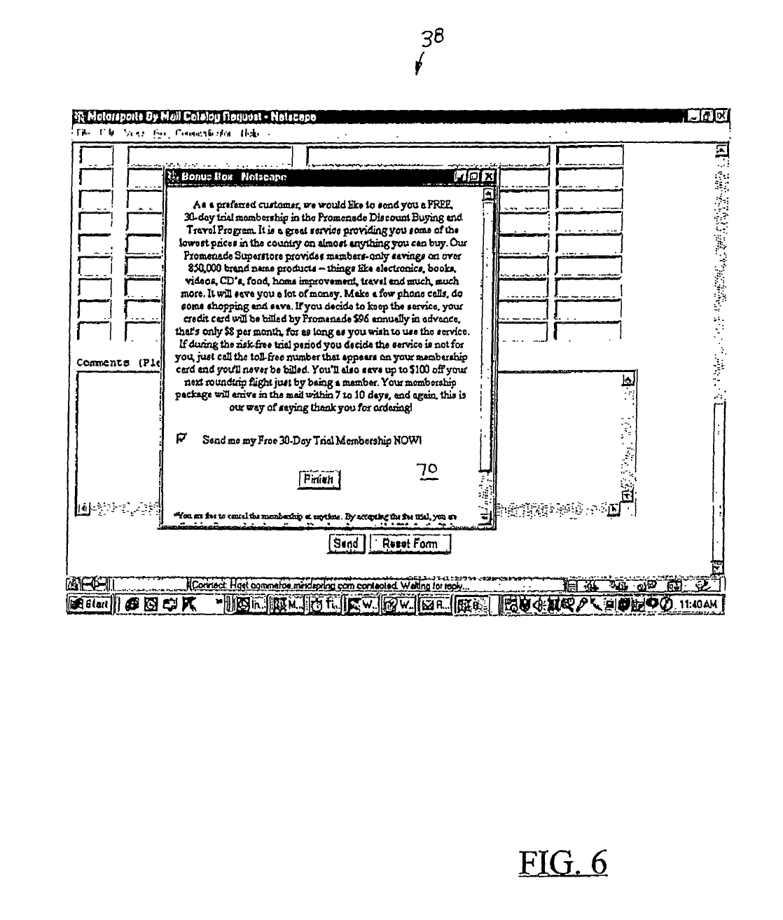

Referring now to FIG. 6, an example upsell offer 38, contained in upsell window 70, is shown. Upsell window 70 is downloaded from upsell server 10 directly to client system 28. If the customer would like to accept the upsell offer 38, the customer can click on the appropriate box in the upsell window 70. Alternatively if the customer is not interested in the upsell offer, the customer can, for example, click on the “X” in the upper right-hand corner of the upsell window 70. If the client does accept the upsell offer 38, an upsell order 40 is placed back with the upsell server 10, where the order is processed. Upsell window 70 then is removed, and control is passed back to client system 28, typically on a web page associated with affiliate server 22.

As an alternative, rather than utilizing a separate pop-up window, the post-sale opportunity and upsell offer could be embedded directly into the affiliate's thank you/receipt/acknowledgment page using, for example, an IFRAME system. Moreover, a Java, Active X, or .NET based pop-up window could be utilized instead of a JavaScript.

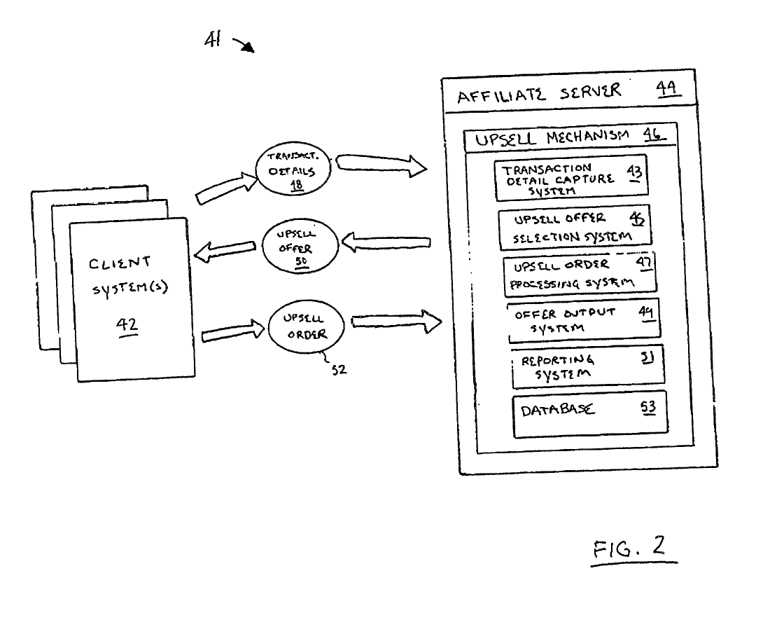

Referring now to FIG. 2, an alternative embodiment of a web-based upsell system 41 is shown. Upsell system 41 is essentially the same system as depicted in FIG. 1, except that the affiliate server 44 handles the upsell process locally with upsell mechanism 46. Accordingly, upsell system 41 does not utilize a third-party upsell server to handle the processing of the upsell offer 50 and upsell order 52.

In a typical scenario, client system 42 will submit transaction details 48 to the affiliate server for an order placed on affiliate server 44. During the completion of the transaction between client system 42 and affiliate server 44, upsell mechanism 46 will utilize upsell offer selection system 45 to select an upsell offer 50, and offer output system 49 to deliver the offer 50 to client 42. If the customer at client system 42 decides to accept the upsell offer 50, an upsell order 52 is sent back to affiliate server 44 where upsell order processing system 47 can receive and handle the processing of the upsell order 52. Upsell mechanism 46 may include a transaction detail capture system 43, a reporting system 51, and a database 53, which perform functions similar to those described above with reference to FIG. 1.

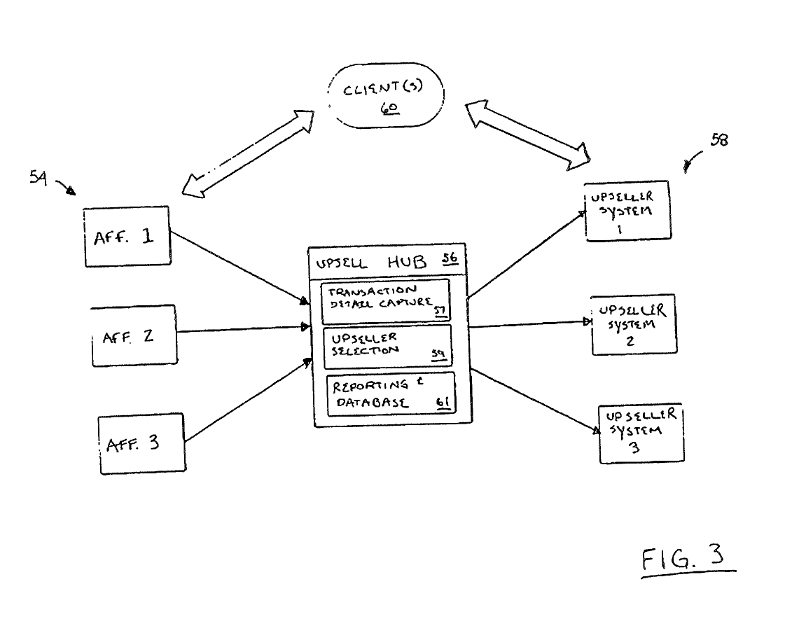

Referring now to FIG. 3, a further embodiment of the invention is shown in the form of upsell hub 56. Pursuant to this embodiment, upsell hub 56 acts as a broker for upsell opportunities. In particular, when an affiliate 54 substantially completes a transaction with a client 60, an upsell opportunity can be transmitted to upsell hub 56, which will in turn select a third party upseller system 58 to handle the actual upsell processing with client 60. The upsell opportunity may transferred from the client or the affiliate. Upsell hub 56 may include a transaction detail capture system 57, an upseller selection system 59, and a reporting and database system 61, like those described above.

It is understood that the various servers, mechanisms and systems described herein may be realized in hardware, software, or a combination of hardware and software. They may be implemented by any type of computer system—or other apparatus adapted for carrying out the methods described herein. A typical combination of hardware and software could be a general purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention have been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

We claim:

1. A method of transacting commerce on a network having a client system, an upsell server system, and an affiliate server system, comprising the steps of:
downloading an affiliate order window to the client system from the affiliate server system;
uploading transaction details from the client system to the affiliate server system;
displaying a post-sale opportunity on the client system, wherein the post-sale opportunity includes upsell details that comprise the transaction details;
if the post-sale opportunity is accepted at the client system, performing the steps of:
transferring the upsell details to the upsell server system; and
downloading an upsell offer from the upsell server to the client system; and
if the upsell offer is accepted, processing an upsell order at the upsell server system using the upsell details.

2. The method of claim 1, comprising the step of running an upsell script from the affiliate order window to cause the post-sale opportunity to be displayed to the client system.

3. The method of claim 1, wherein the transaction details include customer information and order information.

4. The method of claim 3, wherein the upsell offer is determined by:
examining a promotional identifier provided to the affiliate server system from the upsell server system.

5. The method of claim 3, wherein the upsell offer is determined by:
analyzing the upsell details;
selecting an upsell offer based on the analyzed upsell details.

6. The method of claim 3, wherein the customer information includes payment details.

7. The method of claim 6, wherein the step of processing the upsell order at the upsell server system includes the steps of:
analyzing the payment details in the transaction details; and
securing payment for the upsell order using the payment details.

8. The method of claim 1, wherein the post-sale opportunity and the upsell offer are displayed on the client system in the form of a pop-up window.

9. A system for transacting commerce on the world wide web, comprising:
an affiliate website having a system for processing a transaction with a client and for receiving transaction details from the client; and
an upsell servers wherein the upsell server includes:
a system for capturing the transaction details from the client during the transaction between the affiliate website and the client;
a system for providing an upsell offer to the client during the transaction between the affiliate website and the client; and
a system for completing an upsell order with the client using the captured transaction details.

10. The system of claim 9, further comprising an upsell script that is run during the transaction between the affiliate website and the client to create a pop-up window.

11. The system of claim 10, wherein the pop-up window causes the client to transfer transaction details to the upsell server.

12. The system of claim 11, wherein the pop-up window causes affiliate details that include a promotional identifier to be transferred to the upsell server.

13. The system of claim 9, wherein the transaction details include customer details.

14. The system of claim 13, wherein the customer details include payment information.

15. The system of claim 13, wherein the transaction details include affiliate order information.

16. The system of claim 9, wherein the upsell website further includes a system for selecting the upsell offer from a plurality of upsell offers.

17. The system of claim 16, wherein the system for selecting the upsell offer selects the upsell offer based on the transaction details.

18. The system of claim 12, wherein the upsell website further includes a system for selecting the upsell offer from a plurality of upsell offers based on the affiliate identifier.

19. The system of claim 9, wherein the upsell website further includes a system for processing the upsell order.

20. A program product stored on a recordable media, that when executed, includes:
means for capturing transaction details during the processing of a transaction between an affiliate server and a client;
means for providing an upsell offer to the client during the transaction between the affiliate server and the client; and
means for completing an upsell order with the client using the captured transaction details.

21. The program product of claim 20, wherein the program product is executable on a system that includes the affiliate server.

22. A hub system for brokering upsell opportunities between affiliate servers and upseller servers, comprising:
means for capturing upsell opportunities during the execution of transactions between the affiliate servers and their respective clients, wherein each upsell opportunity includes transaction details; and
means for transmitting the captured upsell opportunities to at least one selected upsell server during the execution of said transaction.

23. A system for transacting commerce on the world wide web, comprising:
an affiliate website having a system for processing a transaction with a client and for receiving transaction details from the client; and
an upsell server, wherein the upsell server includes:
a system for capturing the transaction details during the transaction between the affiliate website and the client; and
a system for providing upsell content to the client during the transaction between the affiliate website and the client.

24. The system of claim 23, wherein the upsell content is determined based on the captured transaction details.

25. A method of transacting commerce on a network having a client system, an upsell server system, and an affiliate server system, comprising the steps of:
downloading an affiliate order window to the client system from the affiliate server system;
uploading transaction details from the client system to the affiliate server system;
transferring the transaction details to the upsell server system;
displaying a post-sale opportunity on the client system;
if the post-sale opportunity is accepted at the client system, performing the steps of:
downloading an upsell offer from the upsell server to the client system; and
if the upsell offer is accepted, processing an upsell order at the upsell server system using the upsell details.

26. The method of claim 25, wherein the post-sale opportunity is generated by the upsell server.

27. The method of claim 25, wherein the transaction details include name, payment, and affiliate information.

28. The method of claim 25, wherein the transaction details include a unique identifier.

29. The method of claim 28, wherein the unique identifier is generated by the affiliate server.

30. The method of claim 28, wherein the unique identifier is captured from the order window.

31. The method of claim 25, wherein the post-sale opportunity is displayed in a pop-up window.

32. The method of claim 25, wherein the post-sale opportunity is displayed in an IFRAME window.
